(19) United States
(12) Patent Application Publication
(10) Pub. No.: US 2002/0188745 A1
(43) Pub. Date: Dec. 12, 2002

(54) Stacked stream for providing content to multiple types of client devices

(76) Inventors: David A. Hughes, New York, NY (US); Matthew A. Carpenter, New York, NY (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/878,524

(22) Filed: Jun. 11, 2001

(51) Int. Cl. G06F 15/16

(52) U.S. Cl. 709/231; 709/203

(57) ABSTRACT

A system and method for distributing media files, such as audio or video files, to devices for playback or streaming at various quality levels is provided. In accordance with the method, a stacked media file is provided which has low, medium and high quality information for the same content. The file is transmitted to a receiving device at the highest quality level that the receiving device can decode. The hierarchy of the media file is such that data redundancies are avoided by, for example, stacking the data within the file in such a way that the data is segregated into data sets corresponding to a given sampling rate, with each successive data set containing only those data points not found in the preceding data set. The quality of the data being transmitted to the receiving device may be adjusted, during transmission if necessary, by increasing or decreasing the number of data sets being sampled.

### FIELD OF THE INVENTION

The present invention relates generally to methods and apparatuses for electronically distributing media files to devices for playback, and more particularly to a method and apparatus for electronically distributing a media file to a device for playback at multiple quality levels.

### BACKGROUND OF THE INVENTION

A number of devices are known in the art that are capable of distributing or transmitting an original encoded data stream to a receiving device. The receiving device may itself be capable of receiving the original data stream, decoding it and generating an output data stream corresponding to the input data stream. The output data stream generated by the receiving device may be of the same or of lesser quality than the input data stream.

One particular example of this type of technology is the system employed by RealNetworks™ to distribute audio and video files over the Internet. This system utilizes the benefits of streaming media—the compression of media files, such as audio or video files, for playback over the Internet in real time—to allow users to watch video files or listen to audio files over the Internet. Often, compression is used to minimize the use of Internet bandwidth. In the case of audio files, the files are first encoded for transmission over the Internet using, e.g., a software package called RealEncoder™, which encodes the file in RealAudio™ format using a series of compression/decompression algorithms or CODECs. RealAudio™ files are advantageous in that they are relatively small, so that their use requires less bandwidth.

The RealEncoder™ software gives the user the option of encoding an audio file for different modem speeds. In general, the higher the modem speed for which the file is encoded, the faster the data will stream, and the higher the quality at which it will stream. However, a file encoded at a particular modem speed will only be accessible to a person equipped with a modem and Internet connection capable of operating at a speed equal to or greater than the speed at which the file was encoded. Since a variety of modem and Internet connection speeds are currently in use, it is frequently necessary to encode the same audio file at multiple speeds to accommodate the varying modem speeds of the general public. In order to allow users to access the files, RealNetworks™ provides a software player called RealPlayer™, which is available for free download over the Internet. The RealPlayer™ software includes a bandwidth negotiation algorithm, which customizes presentation quality of streaming audio files to the user's connection speed.

As noted above, bandwidth limitations have typically required that the transmission of audio and video files involve at least one compression step in which the original file is compressed to a smaller size more suitable for transmission, a process achieved through the use of one or more compression algorithms. Most commonly used compression algorithms have at least some degree of lossiness, that is, at least some data is lost from the original file after it is compressed and then decompressed. While some compression algorithms attempt to limit data loss in a way that will not substantially affect the audio or video quality of the subsequently decompressed file, other algorithms accept a certain degree of lossiness in exchange for an improved data transfer rate.

One commonly used compression algorithm is MPEG, a compression standard developed by the Motion Pictures Expert Group. It is most often used for CD-ROM and World Wide Web authoring material. MPEG-1, a particular MPEG species, typically reduces the data size of an uncompressed file by a factor of 100, thus greatly improving the data transfer rate. Though MPEG-1 is a fairly lossy algorithm, it is capable of producing higher compression ratios than both JPEG and MVC1. MPEG-1 is well suited for video publishing, where a video is compressed once and decompressed many times for playback.

Lossiness has also been exploited in some settings for commercial advantage. In particular, some websites exist that have both free and premium content, with the free content being accessible to the general public and the premium content being available only to paid subscribers. Such content, which may include picture or video files, may differ primarily in the degree of lossiness at which it is transmitted to the user, with the premium content having a lower degree of lossiness and hence a higher degree of resolution. Typically, sites that use this approach establish the premium content in one set of media files encoded at a higher sampling rate and the lossier content in another set of media files encoded at a lower sampling rate, the later set of files being those that are accessible by the general public without subscription rights.

While the above noted methods used to accommodate the differing modem speeds or differing subscriber rights of Internet users works well in many respects, it also has some inherent inefficiencies. For example, the current need to store multiple media files of the same content encoded for different modem speeds or subscriber rights involves many redundancies in the data stored. When it is considered that even an average size music Internet site may contain tens of thousands of audio and/or video files for downloading by its subscribers or users and that, even compressed, these files are quite large, these redundancies translate into the need for substantial amounts of extra data storage capacity and a substantial waste of bandwidth. There is thus a need in the art for a method for distributing media files over the Internet or over similar communications media that eliminates such redundancies.

Another problem with the transfer of media files over the Internet arises from bandwidth limitations. At some Internet sites, the quality or degree of lossiness of the data stream that is made available to the user is a function not only of the user's modem speed, but also of the bandwidth available at the site at the time the user accesses it. If several users happen to be accessing the site at the same time, bandwidth limitations may result in a particular user receiving a data stream that is encoded at a lower speed than the user is otherwise capable of receiving, even if additional bandwidth becomes available (e.g., due to some users logging off) during the session. This is due in part to the existence on the site of multiple copies of the same media file, which are encoded for differing access speeds. Consequently, once a user begins to receive data from a particular file, which is encoded at a particular speed, there is no simple way presently available for the user to be shifted seamlessly to a file encoded at a higher sampling rate. There is also no simple method presently available for the user to be shifted seamlessly to a file encoded at a lower sampling rate, should bandwidth availability decrease during the session. There is thus a need in the art for a system and method of seamlessly shifting the quality level of data streaming to a recipient in response to current bandwidth availability.

These and other needs are met by the present invention, as hereinafter described.

### SUMMARY OF THE INVENTION

In one aspect, the present invention relates to a method for distributing media files, such as audio, video or multiplexed files, to devices for playback or streaming at various quality levels, and to a system adapted to implement the method. In accordance with this aspect of the invention, a stacked data file is provided which can provide multiple levels of information quality (e.g., low, medium and high) for the same content. The hierarchy of the data file is preferably such that data redundancies are avoided by, for example, segregating the data file into at least first and second data sets according to sampling rate, frequency, or some other suitable parameter or selection criteria, such that the quality level of the data stream can be adjusted up or down by sampling from a higher or lower number of data sets. Thus, in one particular embodiment, the first data set comprises data points generated at a first sampling rate, and the second data set comprises data points generated at a second sampling rate that are not members of the first data set. In another particular embodiment, the first data set corresponds to data points falling within a first frequency range, and the second data set corresponds to data points falling within a second frequency range which is higher than the first frequency range. A third data set is also provided which corresponds to data points falling within a third frequency range which is lower than the first frequency range. The quality of the information streamed to a recipient in accordance with this method can then be adjusted by simply changing the number of data sets or “stacks” from which the data points are taken. Thus, for example, if a recipient is receiving data at a particular point in time from only the first data set and it is desired to increase the quality of the information made available to the recipient (e.g., because additional bandwidth becomes available, because the rate at which the recipient can receive data increases, or because the recipient obtains subscription rights), the data stream can be seamlessly adjusted, during the transmission if necessary, so that the user is being sent information from both the first data set and one or more additional data sets or stacks, thereby increasing the effective sampling rate and/or frequency bandwidth of the data stream and improving its quality. Likewise, if it becomes necessary, for similar reasons, to decrease the quality of the data stream during transmission, the data stream can be seamlessly adjusted during the transmission so that the number of data sets that the recipient receives information from is reduced.

In another aspect, the present invention relates to a media file, such as an audio, video, or multiplexed file, in which the media data is segregated into at least first and second data sets. The media file is arranged such that a data stream can be generated from the file, and the quality of the data stream can be varied by changing the number of data sets that are sampled. Preferably, the data sets are mutually exclusive so as to avoid redundancy. The media data may be segregated into data sets according to sampling rate, frequency, or some other suitable parameter, such that the quality level of the data stream can be adjusted up or down by sampling from a higher or lower number of data sets, respectively. If the media data is segregated according to sampling rate, for example, the first data set may comprise data points generated at a first sampling rate, and the second data set comprises the difference between the data points generated at the first sampling rate and the data points generated at the second sampling rate (that is, the second data set contains all of the data points generated at the second sampling rate that are not members of the first data set). The difference in sampling rates may be at any desired interval (e.g., 8-bit, 16-bit or 32-bit intervals), and the media file may comprise any desired number of data sets. Media files of this type are particularly well suited for the streaming of media over the Internet or a similar medium such that the quality of the data stream can be readily and seamlessly adjusted, during transmission if necessary, to reflect bandwidth availability, the ability of a recipient to receive data at a given sampling rate at a given point in time, and/or the subscription rights of the recipient, if any.

In still another aspect, the present invention relates to a method for generating a media file, such as an audio file, a video file, or a multiplexed file. In accordance with the method, a set of media data is provided. The media data is then segregated into at least first and second groups of data points on the basis of sampling rate, frequency range, or some other suitable parameter. Thus, for example, the first and second groups of data may comprise data generated at first and second distinct sampling rates, respectively. A media file is then generated based on the first and second groups of data points.

In yet another aspect, the present invention relates to software adapted to implement any of the foregoing aspects of the invention, and to a tangible medium containing such software.

In another aspect, the present invention relates to methods of doing business, which employ the aforementioned aspects of the invention.

### DESCRIPTION OF THE FIGURES

FIG. 1 is a schematic diagram of a system over which the methodology of the present invention may be implemented; and

FIG. 2 is a flowchart illustrating the methodology of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In accordance with the present invention, a method is provided for distributing media files, such as audio, video or multiplexed files, to devices for playback or streaming at various quality levels. The method is particularly well suited for the distribution of music files over the Internet. Systems and software adapted to implement the method are also provided.

The method of the present invention makes advantageous use of a new type of media file which has a novel architecture designed to eliminate the redundancies associated with prior art methods of distributing media files over the Internet. In particular, prior art methods of distributing media files over the Internet have typically required a given media file to be encoded at various sampling rates to accommodate the variable rates at which users can receive data. These rate variations arise because of differences in modem speeds, bandwidth availability, subscription rights, and other such factors. However, this process of encoding files at varying sampling rates inherently involves substantial amounts of redundancy.

For example, a prior art scheme for streaming audio files over the Internet might require a particular audio file to be encoded at three different bit rates: 64 kbps, 96 kbps, and 128 kbps. Assuming that the audio file is approximately 5 minutes in duration, this translates into the need to create three separate files of about 2, 3, and 5 megabytes in size, respectively. The primary difference between the files is the additional data consequential to the higher number of samples required by the higher bit rate. Thus, for example, the 128 kbps file is redundant in that it contains the same information set forth in the 64 and 96 kbps files, plus some additional information, and the 96 kbps file is redundant in that it contains the same information set forth in the 64 kbps file, plus some additional information. Therefore, the total redundancy in this example is about 5 megabytes (the combined size of the two smaller files), so that about 50% of the total encoded data is redundant. When it is considered that a typical Internet website set up for media distribution might be required to carry tens of thousands of titles, encoded at multiple sampling rates, these redundancies translate into the need for excessive amounts of unnecessary bandwidth and storage media.

These redundancies are eliminated through the use of the specially formatted media files of the present invention, which contain media data which is segregated into a plurality of data sets or “stacks” according to, for example, the sampling rate at which it was obtained or the frequency range to which it belongs. The segregation is preferably constructed such that the data in each successive data set contains only data points not found in the preceding data sets, thereby eliminating redundancies. Thus, for example, the media file may comprise first and second data sets, with the first data set comprising data points generated at a first sampling rate, and the second data set comprising those data points generated at a second sampling rate distinct from the first sampling rate which are not found in the first data set.

The data within the individual stacks and/or within the file as a whole may be coordinated or arranged temporally to allow seamless shifting of the number of stacks being sampled during streaming. This may be accomplished, for example, by arranging the data in accordance with a timeline that governs the file as a whole, or by arranging the data within each stack along a given timeline, and then coordinating the timelines of the stacks to allow proper sequential playback of the data. Alternately, each data point within the file may contain a temporal parameter to enable or facilitate proper sequential playback.

In the event that the data in the media file is segregated according to sampling rate, the difference in sampling rates between successive stacks in the file may be set at any desired interval. However, these intervals are typically within the range of 2 to 128 bits, preferably 8 to 32 bits, and most preferably 8 to 16 bits. Moreover, the minimum sampling rate employed in generating a stack or data set within the file may be selected according to the needs of the application, but will typically be at least 16 kbps, more preferably at least 32 kbps, and most preferably at least 64 kbps. The number of stacks in the file will typically be dictated by the maximum amount of resolution to be made available to the user, the interval between stacks, and the minimum sampling rate employed. However, the number of stacks will typically be in the range of 2 to about 50, preferably within the range of 2 to 20, and most preferably within the range of 3 to 10.

Stacking may be accomplished in a variety of ways in accordance with the present invention. However, in one embodiment, the first or primary stack or set of data in the file consists of all of the data points generated at the lowest sampling rate employed, with each successive stack consisting of any data points found at the next highest sampling rate which are not present in any preceding stack. While the stacked data will ordinarily be placed into a single file, embodiments are also contemplated wherein the data present in each stack is placed in a separate file. These separate files may be merely pointed to by a master file, or by the file containing the data with the lowest sampling rate.

In other embodiments of this invention, stacking may be implemented by providing a first media file in conjunction with a difference file. The first media file may consist of, for example, a media file of a known type, which is encoded at a first sampling rate. The first media file may be produced through the use of one or more encoding and/or compression algorithms. The difference file consists of any information gathered at one or more additional sampling rates, which is not already included in the first media file. The data in the difference file is segregated or stacked according to sampling rate, so that the stack corresponding to a given sampling rate has only the information not found in the first media file or in any stacks corresponding to a lower sampling rate. When the data from the file is streamed, the data stream consists of data from the first media file, data from the stack corresponding to the highest sampling rate at which the user is capable of receiving (or the stack corresponding to the highest sampling rate at which the user is entitled to receive data under a subscription plan), and data from any intermediate stacks.

A wide variety of file formats, and the associated compression/decompression algorithms, may be used in conjunction with this last embodiment of the present invention. These include, but are not limited to, MP3, MP3 CBR, MP3 VBR, RealAudio, Windows Media, MOD, 669, AMS, DBM, FAR, MDL, MTM, OKT, SM3, STM, ULT, XM, AIFF, AU, MID (or MIDI), AAC, ATRAC, VOC and WAV formats.

MP3 files of various settings may be used in conjunction with this aspect of the present invention. Thus, MP3 files may be used which are set at 160 kbps with a 9:1 compression ratio, which creates an MP3 file with very low compression and very high sound quality. For this setting, 1 minute of music will equal approximately 1.5 MB of disk space. MP3 files may also be used which are set at 128 kbps, which creates a Windows Media™ file equal to CD quality sound. For this setting, 1 minute of music will equal approximately 1 MB of disk space. MP3 files may also be used which are set at 96 kbps with a 22:1 compression ratio, which creates an MP3 file with the same sound quality as an FM radio station. For this setting, 1 minute of music will equal approximately 750 k of disk space.

Windows® Media files may also be used advantageously in conjunction with this aspect of the present invention, as these files may be customized to various quality levels. Typically, encoding rates of 5 to 160 kbps are available with this file type. Generally, a Windows Media file encoded at 128 kbps will create a Windows Media file equal to CD quality sound. At this setting, 1 minute of music will equal approximately 750 k of disk space. By comparison, a Windows Media file encoded at 64 kbps will create a Windows Media file with the same sound quality as an FM radio station.

MOD files may also be used in conjunction with this aspect of the present invention. MOD files create sounds, which are stored on the file itself as samples. These samples are then modulated, hence the name. The S3M format, which is arguably the most advanced of the mod formats, supports 16-bit samples of varying pitch.

RealAudio® files may also be used in conjunction with this aspect of the present invention. These files provide good sound quality, and are much smaller and therefore faster to download than some other file types such as WAV files. Files of this type require a RealAudio® plug-in to be played.

The methodology of the present invention advantageously utilizes the novel file architectures described herein to stream media files to a recipient. This process typically involves an initial determination of the rate at which a recipient is to receive data. This determination may be based on a variety of factors, including the recipient's modem speed, bandwidth limitations, and the recipient's subscription rights, if any. The data necessary to make this determination may be exchanged through a handshake protocol between the server and the recipient's device and/or through a log-on process, which may involve a user ID and/or password. The recipient is then streamed the primary stack or set of data and the number of additional stacks appropriate for the transfer rate determined for the recipient. Thus, going back to the example discussed above, if this determination is based solely on modem speed, a user with a 128 kbps modem would be streamed the 64 kbps file and the two additional 32-bit stacks, while a user with a 96 kbps modem would be streamed the 64 kbps file and one additional 32-bit stack. If desired, the rate at which a recipient is to receive data may be re-evaluated periodically during the streaming process, at which point appropriate adjustments in the transfer rate may be made.

It is to be noted that, for ease of illustration, the possible need for additional bits pertaining to overhead information that may be required for the management of the segregation and streaming of data has been ignored. However, one skilled in the art will appreciate that additional information enabling this function may be built into the file and/or data stacks. Alternatively, this role may be performed in whole or in part by the player software.

The method of streaming data in accordance with the present invention provides a convenient mechanism for operating a server that has both subscription and non-subscription content which differs in the degree of resolution afforded to the user. In one particular embodiment of this aspect of the invention which is adapted to an Internet subscription service, a stacked media file is provided in which the first stack is encoded at the quality level that the service provider wishes to make available to the general public at either no cost or at a reduced cost. The additional data stacks, which essentially provide the data needed to improve the resolution of the media file, are then made available only to service subscribers. In some variations in this embodiment, the number of stacks made available to the user is a function of the user's subscription plan, while in other variations, a single subscription fee grants the user access to the maximum number of stacks that his or her modem can accommodate.

Alternately, the system may be arranged so that the maximum number of stacks streamed to a non-subscriber user may be conveniently limited to some fixed amount, regardless of the user's modem speed or ability to receive data, thus resulting in a lower quality audio or video output. By contrast, the number of stacks streamed to a user having subscription rights may be limited only by the subscriber's modem speed and/or the total number of stacks available for streaming.

The method of streaming data in accordance with the present invention also provides a convenient method for adapting to bandwidth limitations and fluctuations in server traffic. In particular, when server traffic is low, data can be streamed to each user at the highest sampling rate appropriate for their modem. As server traffic increases, however, the additional users can be accommodated by seamlessly transitioning the data stream to a lower sampling rate (e.g., sending a particular recipient a lower number of data stacks), thereby preserving available bandwidth.

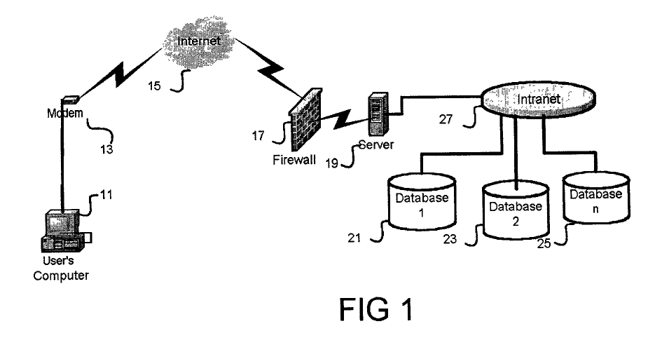

FIG. 1 illustrates a non-limiting example of a system over which the method of the present invention can be implemented. A user's computer 11 is connected to the Intranet 15 via a modem 13. While a modem is shown, the modem could be a cable modem, a standard dial-up modem, or a network interface. A connection to the server 19 over which the media files are streamed may be obtained through a firewall 17. The server is in contact with media file databases 21, 23 and 25 via an intranet 27. While multiple databases are shown, the system could be implemented with a single database. The stacked files of the present invention are stored in the databases, which can be queried by the user via a standard Boolean search engine. In response to a query and upon selection by a user of a result of the query, the server determines the connection speed to the user's computer and selects the apprpriate portion of the stacked data file for streaming to the user. Upon buffering an initial amount, the user's computer begins playing the selected query result (i.e., a media file). As the connection speed to the user changes based on network congestion or on other factors, the server dynamically switches between the various portions of the stacked file according to the present invention. Each of these portions represents a different quality version of the media file (e.g., various sampling rates). For example, assuming the initial determination by the server when establishing the connection to the user identified a middle quality level of the selected file as being best suited to the user's current connection speed, upon a reduction in the connection speed, the server dynamically switches to a lower quality version of the selected file now deemed best suited to the user's reduced connection speed. In addition, if the connection speed to the user improved from the initially determined rate, the server would switch automatically to a higher quality file. Thus, as part of this process, the server monitors the instantaneous connection speed to the user and changes the quality version of the selected file as a function of the instantaneous connection speed to the user. By so doing, the server ensures an optimal experience by the user.

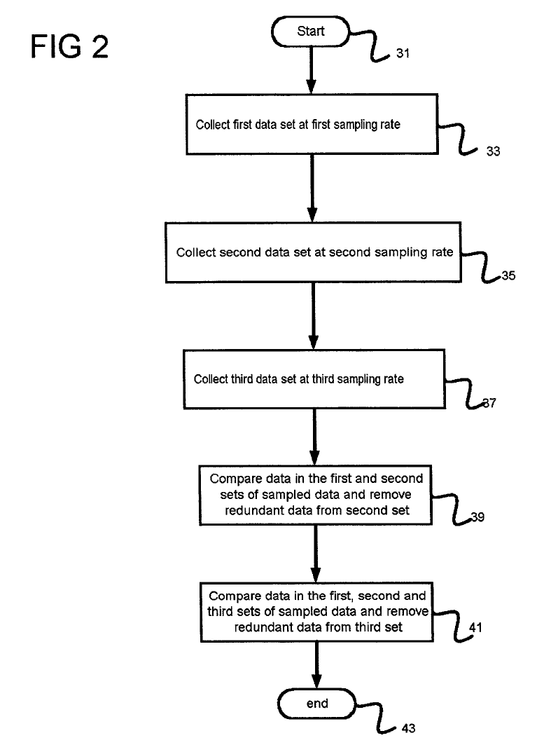

FIG. 2 illustrates an example of the methodology that can be used to build stacked files in accordance with the present invention. At the start 31, a first data set is collected 33 at a first sampling rate, a second data set is collected 35 at a second sampling rate, and a third data set is collected 37 at a third sampling rate. The second data set is then compared to the first data set and any redundancies are removed from the second data set 39. The third data set is then compared to the first and second data sets and any redundancies are removed from the third data set 41.

According to this aspect of the present invention, the lowest sampling rate data set represents a base quality version of a given file and the other data sets represent difference files between successively higher quality versions of the given file and the base version in a hierarchical structure. Thus, the present invention provides a minimal amount of storage per media file, and a concomitant reduction in overall storage capacity of a database of such files. Moreover, the present invention provides a convenient technique for dynamically switching between various quality levels of a given media file without necessitating redundant storage.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats or protocols may suffice. Moreover, while some of the embodiments describe specific embodiments of computer, clients, servers, etc., other types may be employed by the invention described herein. Furthermore, these examples should not be interpreted to limit the modifications and variations of the invention covered by the claims but are merely illustrative of possible variations.

What is claimed is:

1. A method for streaming data, comprising the steps of:
providing a file comprising media data, said media data being segregated into at least a first and second data set, wherein said first data set contains data points generated in accordance with a first selection criteria and wherein said second data set contains data points generated in accordance with a second selection criteria that are not members of the first data set; and
transmitting the data from at least the first data set to a user.

2. The method of claim 1, wherein said first data set contains data points generated at a first sampling rate, and wherein said second data set contains only those data points generated at a second sampling rate that are not members of the first data set.

3. The method according to claim 1, wherein the file is an audio file.

4. The method according to claim 1, wherein the file is a video file.

5. The method according to claim 1, wherein the file is multiplexed.

6. The method according to claim 2, wherein the first sampling rate is no greater than 64 kbps, and wherein the second sampling rate is no less than 80 kbps.

7. The method according to claim 2, wherein the first sampling rate is no greater than 64 kbps, and wherein the second sampling rate is no less than 96 kbps.

8. The method according to claim 1, wherein the data selected for transmission to the user is adjustable during transmission between a first state in which the data is selected only from the first data set to a second state in which the data is selected from both the first and second data set.

9. The method according to claim 8, wherein the data selected for transmission to the user is determined by available bandwidth.

10. The method according to claim 8, wherein the data selected for transmission to the user is determined by the user's subscription status.

11. The method of claim 1, wherein the first selection criteria is the condition that each data point in the first data set falls within a first frequency range, and wherein the second selection criteria is the condition that each data point in the second data set falls within a second frequency range mutually exclusive of said first frequency range.

12. A media data file, comprising:
first and second segregated data sets, said first data set containing data points generated at a first sampling rate, and said second data set containing only those data points generated at a second sampling rate that are not members of said first data set.

13. The media file according to claim 12, further comprising a third data set containing only those data points generated at a third sampling rate that are not present in said first and second data sets.

14. The media file according to claim 12, wherein the second sampling rate is at a higher frequency than the first sampling rate.

15. The media file according to claim 12, wherein the third sampling rate is at a higher frequency than either the first or the second sampling rate.

16. The media file of claim 12, wherein the media file is an audio file.

17. A method for generating a media file, comprising the steps of:
providing a first and second group of data points generated at a first and second sampling rate, respectively, said second sampling rate being higher than said first sampling rate; and
generating a media file based on the first and second groups of data points, the media file comprising first and second segregated data sets, said first data set containing data points generated at a first sampling rate, and said second data set containing only the data points generated at a second sampling rate that are not found in the first data set.

18. The method according to claim 17, wherein the second sampling rate is at a higher frequency than the first sampling rate.

19. A computer readable medium having encoded therein programming instructions causing a processor to:
generate a media file based on a first and second group of data points generated at a first and second sampling rate, respectively, said second sampling rate being higher than said first sampling rate, the media file comprising first and second segregated data sets, said first data set containing data points generated at the first sampling rate, and said second data set containing only the data points generated at the second sampling rate that are not found in the first data set.

20. The computer readable medium of claim 19, wherein said media file is a compressed media file.

21. The computer readable medium of claim 19, wherein the second sampling rate is at a higher frequency than the first sampling rate.

22. A method for generating a compressed media file, comprising the steps of:
providing a file comprising a first and second group of data points generated at a first and second sampling rate, respectively, said second sampling rate being at a higher frequency than said first sampling rate; and
generating a compressed media file based on said first and second groups of data, said file comprising a first data set containing data points generated at the first sampling rate, and a second data set containing only those data points generated at the second sampling rate that are not found in the first data set.
